(19) United States
(12) Patent Application Publication
(10) Pub. No.: US 2022/0132381 A1
(43) Pub. Date: Apr. 28, 2022

(54) USER PLANE ADAPTATION FOR MOBILE INTEGRATED ACCESS AND BACKHAUL

(71) Applicant: AT&T INTELLECTUAL PROPERTY I, L.P., Atlanta, GA (US)

(72) Inventors: Thomas Novlan, Cedar Park, TX (US); Milap Majmundar, Austin, TX (US)

(21) Appl. No.: 17/237,191

(22) Filed: Apr. 22, 2021

Related U.S. Application Data
(60) Provisional application No. 63/104,752, filed on Oct. 23, 2020.

(51) Int. Cl. H04W 36/08; H04W 76/20; H04W 8/02

(52) U.S. Cl. CPC H04W 36/08; H04W 8/02; H04W 76/20

(57) ABSTRACT

The described technology is generally directed to supporting user plane adaptation via mobile relays based on the integrated access and backhaul (IAB) features of 5G New Radio. In various aspects, signaling and procedures are provided for reconfiguring radio bearers of a group of one or more user equipment (UE) devices over multiple routes during IAB topology adaptation procedures, including in scenarios with and without a need to update security key parameters at UEs. The signaling and procedures, in both single connectivity and multi-connectivity scenarios, facilitate access UE devices maintaining user plane connectivity to their anchor serving cell, even when a mobile IAB node to which the UE devices are connected performs a mobility procedure (e.g., handover or SCG change).

### CROSS-REFERENCE TO RELATED APPLICATION

This non-provisional application claims priority to U.S. Provisional Patent Application No. 63/104,752, filed on Oct. 23, 2020, and entitled “USER PLANE ADAPTATION FOR MOBILE INTEGRATED ACCESS AND BACKHAUL.” The entirety of the aforementioned provisional application is hereby incorporated herein by reference.

### TECHNICAL FIELD

The subject application is related to wireless communication systems, and, for example, to user plane adaptation via mobile relays based on integrated access and backhaul, and related embodiments.

### BACKGROUND

Due to the larger bandwidth available for New Radio (NR, e.g., in the mmWave spectrum) compared to LTE along with the native deployment of massive MIMO (Multiple-Input Multiple-Output) or multi-beam systems in NR, integrated access and backhaul (IAB) links can be developed and deployed. This may, for example, allow easier deployment of a dense network of self-backhauled NR cells in a more integrated manner by building upon many of the control and data channels/procedures defined for providing access to user equipment (one or more UEs). In general, a network with such integrated access and backhaul includes relay node (Relay Distributed Unit, or DU) that can multiplex access and backhaul links in time, frequency, or space (e.g., beam-based operation)

In Release 16 of 3GPP (Third Generation Partnership Project) specification, an IAB framework based on fixed relays is standardized. In Release 16, an IAB framework allows for a multi-hop network based on a hierarchical tree architecture. One of the fundamental limitations of the Release 16 IAB framework is that the relay nodes (also referred to as IAB nodes) have to be fixed. However, an IAB node can be mobile, which can impact access UEs even if they remain connected to the same mobile IAB node, because IAB node mobility can change the control plane termination point for the access UEs and IAB node.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system in which integrated access and backhaul (IAB) nodes are hierarchically arranged, including with a child IAB node configured for dynamic frame schedule coordination, in accordance with various aspects and embodiments of the subject disclosure.

FIG. 2 is an example architecture illustrating separation of user plane and control plane in integrated access and backhaul links, in accordance with various aspects and embodiments of the subject disclosure.

FIG. 3 illustrates an example user plane topology and an example control plane topology for mobile integrated access and backhaul links, in accordance with various aspects and embodiments of the subject disclosure.

FIG. 4 illustrates an example of group mobility for mobile integrated access and backhaul, in accordance with various aspects and embodiments of the subject disclosure.

FIG. 5 is representation of example bearer options, including in a mobile integrated access and backhaul environment, in accordance with various aspects and embodiments of the subject disclosure.

FIG. 6 is a representation of example components and data communications between the components, including a transparent downstream group mobility modification request message sent from a migrating integrated access and backhaul node to a source donor node in a single connectivity scenario, in accordance with various aspects and embodiments of the subject disclosure.

FIG. 7 is a representation of example components and data communications between the components, including a direct downstream group mobility modification request message sent from a migrating integrated access and backhaul node to a serving integrated access and backhaul node in a single connectivity scenario, in accordance with various aspects and embodiments of the subject disclosure.

FIG. 8 is a representation of example components and data communications between the components, including a transparent downstream group mobility modification request message sent from a migrating integrated access and backhaul node to a source donor node in a multi-connectivity scenario, in accordance with various aspects and embodiments of the subject disclosure.

FIG. 9 is a representation of example components and data communications between the components, including a direct downstream group mobility modification request message sent from a migrating integrated access and backhaul node to a serving node in a multi- connectivity scenario, in accordance with various aspects and embodiments of the subject disclosure.

FIG. 10 is a flow diagram showing example operations related to determining that a group mobility event is to occur, and triggering a bearer reconfiguration in response thereto, in accordance with various aspects and embodiments of the subject disclosure.

FIG. 11 is a flow diagram showing example operations related to determining that a group mobility event is to occur, and triggering a radio resource reconfiguration in response thereto, in accordance with various aspects and embodiments of the subject disclosure.

FIG. 12 is a flow diagram showing example operations related to determining that a group mobility event is to occur, and informing a serving node in response thereto, in accordance with various aspects and embodiments of the subject disclosure.

FIG. 13 illustrates an example block diagram of an example user equipment that can be a mobile handset in accordance with various aspects and embodiments of the subject disclosure.

FIG. 14 illustrates an example block diagram of a computer that can be operable to execute processes and methods in accordance with various aspects and embodiments of the subject disclosure.

### DETAILED DESCRIPTION

Various aspects of the technology described herein are directed towards user plane adaptation via mobile relays based on the integrated access and backhaul (IAB) features of 5G New Radio and beyond. When a mobile IAB node changes topology as a result of a mobility event, radio bearers of a group of one or more user equipment (UE) devices over multiple routes are reconfigured during the IAB topology adaptation via signaling and procedures. The signaling and procedures facilitate access UE devices maintaining user plane connectivity to their anchor serving cell, even when a mobile IAB node performs a mobility procedure (e.g., handover or SCG change).

As will be understood, the described technology reduces service interruption at the access UE during the group mobility event because the user plane reconfiguration procedures, such as bearer split/switch, are proactively performed before any user plane loss of performance is detected at a donor node. In case of multi-connectivity, master cell group (MCG) bearers, secondary cell group (SCG) bearers, and split bearers can be supported and reconfigured by the mobile IAB architecture during group mobility events. As will be further understood, the described technology facilitates reduced signaling overhead and latency, as the existing radio resource control (RRC) messages can be reused and assistance information can be provided directly from the migrating IAB nodes to an appropriate IAB donor node where the master node (MN) or secondary (SN) is located. Still further, reduced signaling volume related to security key updates and other inter-gNB handover related messages are provided in scenarios where there is a change of termination point during inter-donor IAB node migration, in both single connectivity and multi-connectivity scenarios.

It should be understood that any of the examples and terms used herein are non-limiting. For instance, the examples are based on New Radio (NR, sometimes referred to as 5G) communications between a user equipment device exemplified as a smartphone, mobile device or the like and network node devices; however virtually any communications devices may benefit from the technology described herein. Thus, any of the embodiments, aspects, concepts, structures, functionalities or examples described herein are non-limiting, and the technology may be used in various ways that provide benefits and advantages in radio communications in general.

In some embodiments the non-limiting term “radio network node” or simply “network node,” “radio network device or simply “network device” is used herein. These terms may be used interchangeably, and refer to any type of network node that serves user equipment and/or connected to other network node or network element or any radio node from where user equipment receives signal. Examples of radio network nodes are Node B, base station (BS), multi-standard radio (MSR) node such as MSR BS, gNodeB, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used. It refers to any type of wireless device that communicates with a radio network node in a cellular or mobile communication system. Examples of user equipment are target device, device to device (D2D) user equipment, machine type user equipment or user equipment capable of machine to machine (M2M) communication, PDA, Tablet, mobile terminals, smart phone, laptop embedded equipped (LEE), laptop mounted equipment (LME), USB dongles etc.

Some embodiments are described in particular for 5G new radio systems. The embodiments are however applicable to any radio access technology (RAT) or multi-RAT system where the user equipment operates using multiple carriers e.g., LTE FDD/TDD, WCMDA/HSPA, GSM/GERAN, Wi Fi, WLAN, WiMax, CDMA2000 etc.

The embodiments are applicable to single carrier as well as to multicarrier (MC) or carrier aggregation (CA) operation of the user equipment. The term carrier aggregation (CA) is also called (e.g., interchangeably called) “multi-carrier system”, “multi-cell operation”, “multi-carrier operation”, “multi-carrier” transmission and/or reception. Note that the solutions outlined applies for Multi RAB (radio bearers) on some carriers (that is data plus speech is simultaneously scheduled).

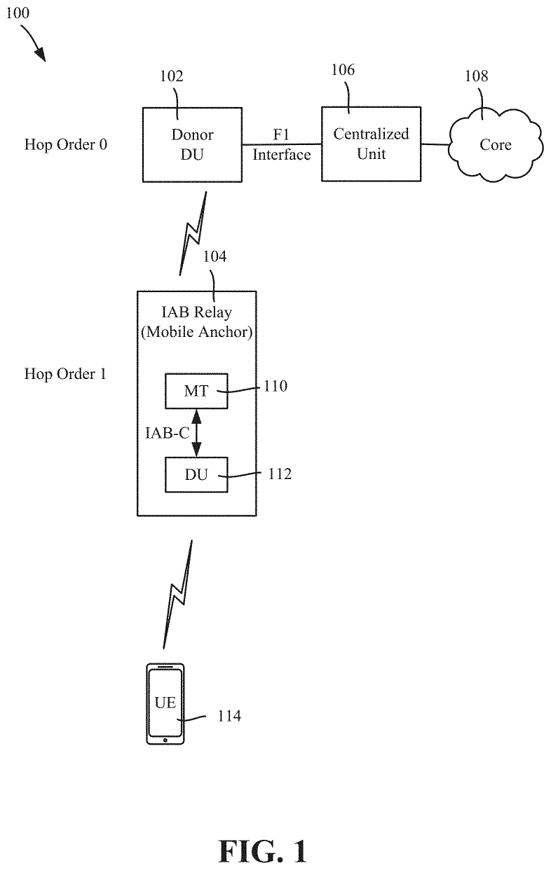

FIG. 1 illustrates an example wireless communication system 100 comprising a multiple hop (multi-hop) integrated access and backhaul network in accordance with various aspects and embodiments of the subject technology. As shown in FIG. 1, the design of a multi-hop IAB network in 3GPP is based on a hierarchical concept that allows use of existing access downlink (DL) and uplink (UL) procedures and channels to create a multi-hop network. This is arranged by having a donor node 102 (at hop order 0), comprising a distributed unit, be a hierarchical parent to an IAB relay node 104 (and possibly others at hop order 1), which can be a parent of a further child relay node (at hop order 2, not explicitly shown in FIG. 1) and so on. The donor node 102 is coupled via an F1 interface to a centralized unit (CU) 106 and the core 108. Note that FIG. 1 is only one example hierarchical IAB configuration, and, for example there can be a greater number hop orders, and indeed, only hop order 0 and hop order 1 are shown in FIG. 1.

To act as an IAB link, each relay node is configured with a mobile UE function (alternatively referred to and shown in FIG. 1 as an MT (mobile termination) function 110) and a gNB (gNodeB) or distributed unit (DU) function 112 (IAB-DU) at each relay. The MT function is used for communicating with the parent node(s), whereas the IAB-DU function is used for communicating with any further child node(s) and/or a UE 114; other UEs may be coupled thereto. Note that the IAB relay 104 is a mobile node that can act as an anchor node as described herein.

In various embodiments, the system 100 can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

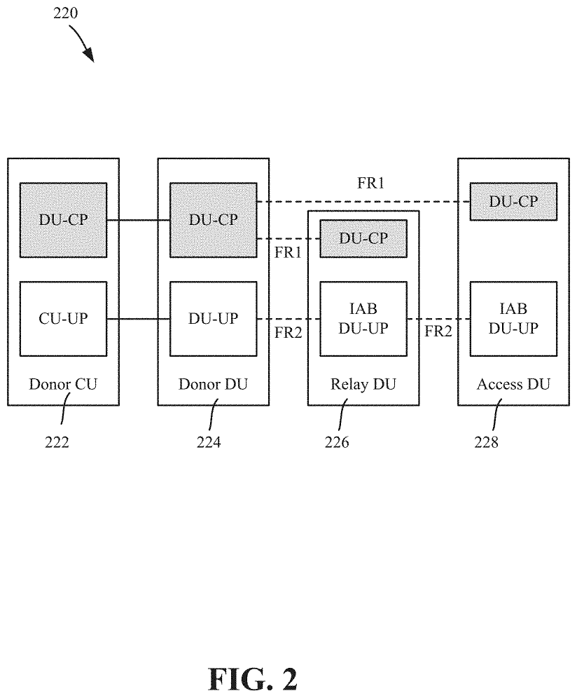

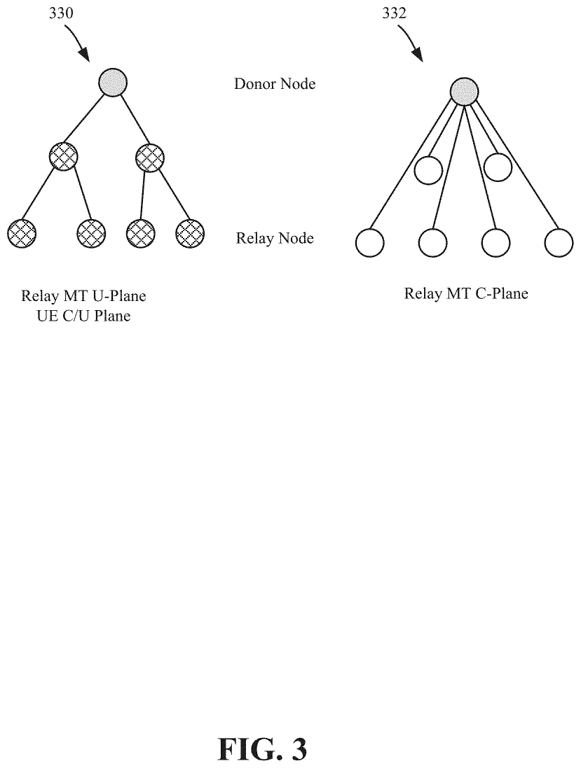

In order to have a robust and reliable solution for the deployment of mobile IAB nodes in the network, a different architecture is described in which the control plane architecture and the user plane architecture of the relay node are separated. The user plane is based on a multi-hop architecture that is similar to that of Release 16 IAB; however the control plane is based on a star architecture where each relay-MT (mobile termination) function is directly connected to the donor. This implies that for the control plane, every IAB node is exactly one hop away from the donor node. This is shown in FIG. 2 as the architecture 220 (showing separation of user plane (UP) and control plane (CP) architecture) for the donor centralized unit 222, donor distributed unit 224, relay distributed unit 226 and access distributed unit 228, and in FIG. 3 as the topology of such a mobile IAB network (topology of control plane 330 and user plane 332 for mobile IAB) where the U-plane and C-plane have separate architecture. Note that in FIG. 2 the control plane includes F1-AP (F1 interface application protocol) messages sent to the access DU 228 at the relay node 226, or RRC (radio resource control) messages sent to the MT (not explicitly shown) at the relay node 226, or RRC messages sent to the user equipment (UE. not explicitly shown) being served by the access DU 228.

A benefit of such a separation of the control and user plane is that mobility and handover of a given node does not trigger handover of a child node because each node's control-plane (primary) connection is directly to the donor as in FIG. 3. This is particularly true when the control plane is connected via sub-6 GHz (FR1) frequencies that allow longer range connectivity compared to mmWave (FR2) frequencies. As also indicated in FIG. 2, the use of FR1 (Frequency Range 1) for the control plane connection makes it possible to significantly reduce the need for handover of the child node.

However, this solution may not be applicable in the case of standalone NR deployments because the access UEs need the CP plane to be provided by their serving IAB node, and mobility events of an IAB node across CU-CPs (centralized unit control planes)/gNBs may still trigger RRC signaling for access UEs, even though their serving IAB node has not changed.

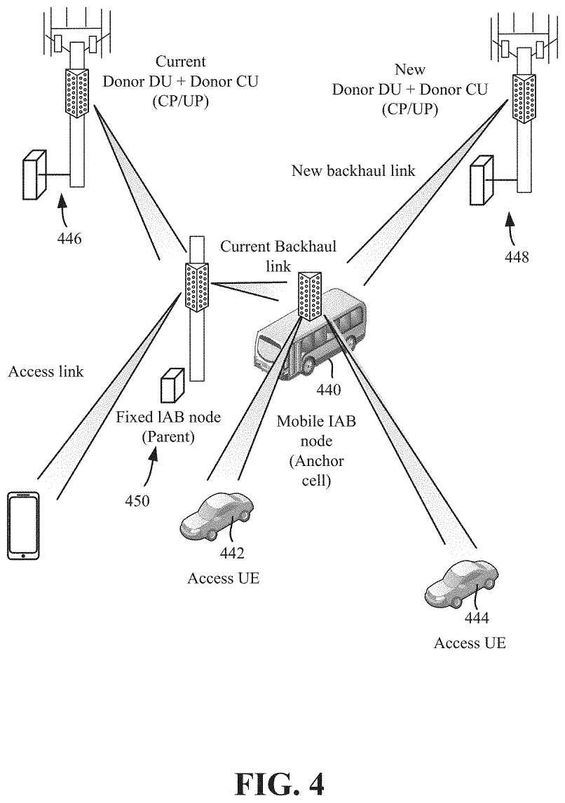

Additionally, mobility of an IAB node can impact access UEs even if they remain connected to the same IAB node, particularly in the case where the IAB node mobility is across Donor CUs/gNBs, because this changes the CP termination point for the UEs and IAB node. As shown in the example of group mobility for mobile IAB in FIG. 4, a mobile IAB node 440 acts as an “anchor” cell for the access UEs 442 and 444 because the donor nodes 446 and 448, and even intermediate IAB nodes (e.g., the fixed IAB node 450) may change during the mobile IAB node's mobility event, but the access UEs' best serving cell is still provided by the mobile IAB node 440. This type of mobility scenario, where the donors 446 and 448 change but the anchor node 440 does not change, is referred to as “Group Mobility.”

Optimizations for the control plane of UEs and IAB MTs during such a mobility event as shown in FIG. 4 may result in reduced RRC signaling and procedures being triggered, such as reconfigurationWithSync in case of PCell (for standalone SA deployments) or pSCell (for NSA non-standalone deployments).

However, the user plane may additionally be impacted during these procedures because user plane data may additionally be carried over multiple routes of the backhaul topology and/or multiple carrier frequencies (e.g., FR1/FR2) if multi-connectivity is supported by the access UEs 442, 444 or the IAB nodes. Described herein is a technology that provides more efficient signaling and procedures to support adaptation of user plane configurations during group mobility and IAB topology adaptation events.

More particularly, described herein is a technology including a method and apparatus to support user plane adaptation via mobile relays based on the IAB (integrated access and backhaul) feature of 5G NR. More particularly, the technology provides signaling and procedures for reconfiguring radio bearers of a group of one or more UEs over multiple routes during IAB topology adaptation procedures, including scenarios with and without a need to update security key parameters at UEs. That is, the technology includes support for multi-connectivity as well as procedures with or without security key changes.

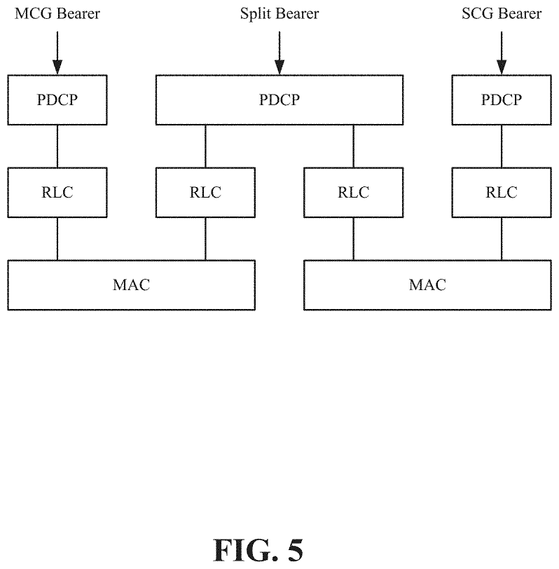

With respect to user plane adaptation during group mobility events, in the case of multi-connectivity, a UE can be configured with one of three different bearer types, namely MCG (master cell group) bearer, SCG (secondary cell group) bearer and split bearer as shown in the bearer options of FIG. 5. In case of single-connectivity, only the MCG bearer type is used.

As described herein, mobility of an IAB node can impact access UEs even if they remain connected to the same IAB node, particularly in the case where the IAB node mobility is across donor CUs/gNBs. This is because such IAB mobility changes the CP/UP termination point for the UEs and IAB node (also known as a group mobility event).

In case of single-connectivity scenario, only a single route is utilized for transporting the user plane data from the donor node (e.g., the donor node 446 of FIG. 4) to the access UE (e.g., the access UE 444), which potentially traverses multiple hops (e.g., via relay node 450) to the anchor IAB node 440 that is serving the access UE. If the group mobility event only involves adaptation of the topology within the same donor node, e.g., the donor node 446, there may be service interruption as the routes are reconfigured and the anchor node (or its parent nodes) completes the migration procedures (e.g., handover, dual-active stack protocol switch, or cell group change). However, if the group mobility event crosses donor node boundaries, e.g., from the donor node 446 to donor node 448, this will involve a change in the user plane configuration as well, because the access UE 444 will be served by a new donor node 448 after the anchor/parent node's migrations along the new route. This can involve further service interruption due to the need for the donor nodes 446 and 448 to exchange signaling to update the user plane and bearer configurations for the access UE 444. In addition, after the bearer configuration change, the PDCP and RLC protocol layers may need to be re-established and the MAC reset if this results in a need for a security key change.

In one alternative, the migrating IAB node (e.g., 440) that is performing the group mobility procedure (e.g., topology adaptation via handover/SCG change) may inform the CU-UP associated with its serving donor node 446 in a Transparent Downstream Group Mobility Modification Request Message (T-DGMMR) that the group mobility/topology adaptation procedure has been triggered and/or initiated and to trigger bearer configuration for its descendent nodes, which may be one or more IAB nodes and/or access UEs that are directly served by the migrating IAB node, or node(s) on a backhaul route that traverses the migrating IAB node 440 and will be impacted by the procedure. Additionally, if the bearer configuration involves migration of the user plane termination point from the current serving donor node's CU-UP to a new target donor node 448 (i.e., inter-donor migration), the notification in the T-DGMMR may also be provided to the target donor node 448 either directly by the migrating node 440 or indirectly by an inter-donor node message from the source donor node to the target donor node. In the latter case, the source donor could trigger the bearer reconfiguration by sending a T-DGMMR to the target donor based on observed measurement reports received from the migrating IAB node.

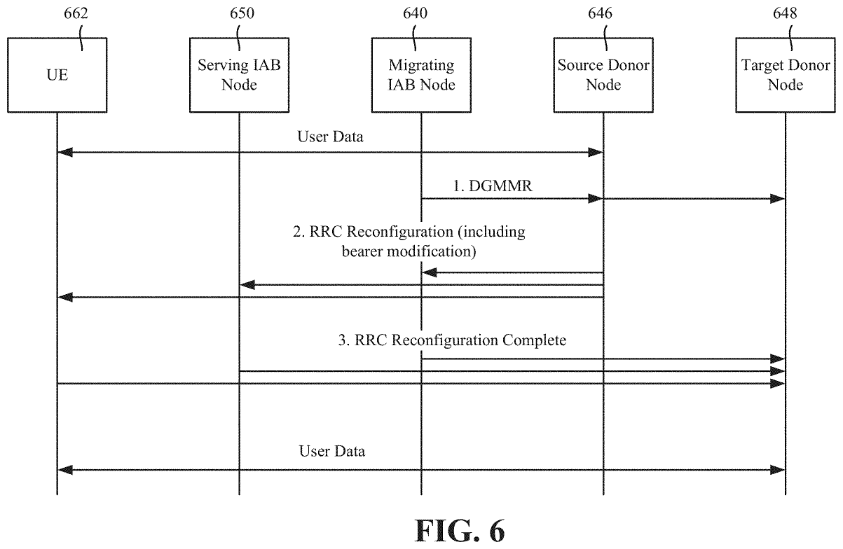

FIG. 6 provides an example of the group mobility procedure with the T-DGMMR (transparent DGMMR procedure for single connectivity). Initially, user data is provided over the multi-hop topology via the source donor node 646, however when the migrating IAB node 640 becomes aware of a topology change requiring a group mobility event, the migrating IAB node 640 sends a DGMMR to the source donor node 646, which may also be forwarded to the target donor node 648. The DGMMR is used at the source node 646 to preemptively trigger RRC reconfigurations (i.e. as part of a handover procedure) for the migrating IAB node 640 as well as the downstream IAB nodes (e.g., the serving IAB node 650) and access UE(s) such as the UE 662, reducing the required signaling within the IAB topology during the group mobility event. After the group mobility procedure, the user data is now terminated at the target donor node 648.

An advantage of this approach is that the bearer configuration modification request is made by the nodes that are directly aware of the topology adaptation procedure and have fewer hops to reach the donor node compared to the downstream IAB nodes/access UEs, which reduces latency and signaling overhead since a single T-DGMMR can be provided for groups of descendent nodes/UEs.

In a second alternative, the migrating IAB node that is performing the group mobility procedure (e.g., topology adaptation via handover/SCG change) may inform its descendent nodes, which may be one or more IAB nodes and/or access UEs that are directly served by the migrating IAB node or are on a backhaul route which traverses the migrating IAB node and will be impacted by the procedure in a Direct Downstream Group Mobility Modification Request Message (D-DGMMR) that the group mobility/topology adaptation procedure has been triggered and/or initiated. In this case, the descendent nodes of the migrating IAB Node may trigger bearer configuration modification request messages for their access UEs that are directly served by the descendent IAB node and may forward the D-DGMMR further downstream or initiate a new D-DGMMR message for the nodes even further downstream.

An advantage of this alternative approach is that it aligns more closely with the legacy procedures in which the serving node (e.g., the anchor node for the access UE in the IAB topology) provides the bearer Modification Request Message to the CU-UP and only introduces new signaling within the RAN. Additionally, the D-DGMMR allows individual downstream nodes to make different decisions related to the type or whether to request a bearer modification, depending on the type of topology adaptation (e.g., for intra-donor vs. inter-donor) or bearer type.

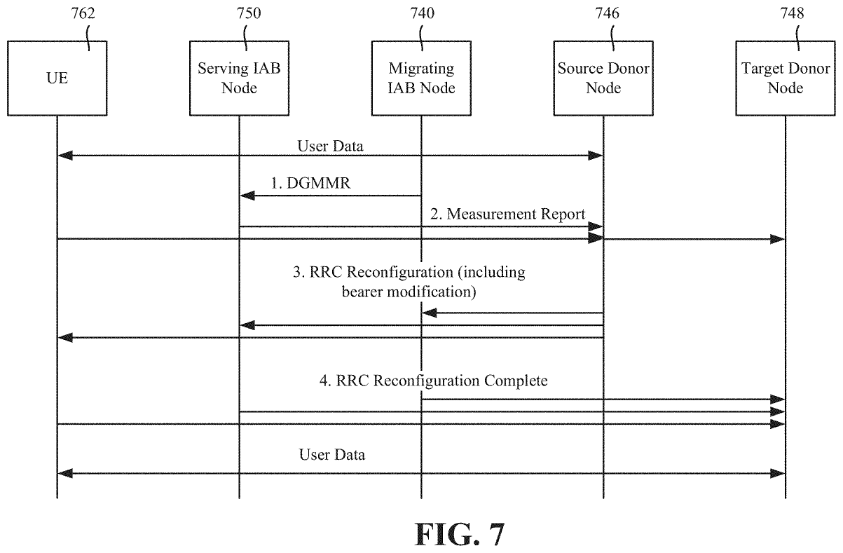

FIG. 7, showing a direct DGMMR (D-DGMMR) procedure for single connectivity, provides an example of the group mobility procedure with the D-DGMMR. Initially, user data is provided over the multi-hop topology via the source donor node 746, however when the migrating IAB node 740 becomes aware of a topology change requiring a group mobility event, the migrating IAB node 740 sends a D-DGMMR to the serving IAB node 750. The D-DGMMR is used at the serving node 750 to preemptively trigger measurement reports from the serving IAB node and UE's RRC reconfigurations (i.e. as part of a handover procedure) for the serving IAB node's access UEs, reducing the latency of the group mobility procedure within the IAB topology. After the group mobility procedure, the user data is now terminated at the target donor node 748.

The DGMMR message may include a dataset (e.g., a list) of one or more impacted downstream links. In one example, the granularity of the notification is on a per-UE bearer level. In a second example. the granularity of the notification is on a per backhaul RLC-channel level, which can reduce the signaling needed because multiple bearers may be aggregated on a single backhaul RLC channel, and additionally allows the DGMMR to be aligned with the Backhaul Adaptation Protocol (BAP) layer that maintains the mapping of bearers to backhaul RLC (radio link control) channels based on the network topology and QoS profiles. In a third example, the granularity may be on an end-to-end (E2E) backhaul route level.

The DGMMR may be carried on a F1-AP message if processed by the IAB node's IAB-DU function, carried on a RRC message if processed by the IAB node's IAB-MT function, or carried on the BAP layer if transported within the RAN by either the IAB-DU or IAB-MT functions. In one example, the DGMMR from the migrating node provides the same or a subset of information as the RRC reconfiguration message sent by the serving node. In a second example, the DGMMR encapsulates the entire RRC reconfiguration message or a subset of the RRC reconfiguration message prepared by the serving IAB node.

In case of multi-connectivity, that is, a multi-connectivity scenario, multiple routes may be utilized for transporting the user plane data from the donor nodes (master node, MN and secondary node, SN) to the access UE, which potentially traverses multiple hops to the anchor IAB node that is serving the access UE. If the group mobility event only involves adaptation of the topology within one of the donor nodes, there may be service interruption for the associated bearer (e.g., MCG bearer for MN (master node) change, SCG bearer for SN (secondary node) change, or the MN-part or SN-part of the split bearer) as the routes are reconfigured and the anchor node (or its parent nodes) complete the migration procedures (e.g., handover, dual-active stack protocol switch, or cell group change). As a result, the DGMMR described herein may need to be provided to the MN donor CU-UP, SN donor CU-UP, or both. As a result, in one example the DGMMR may also indicate the bearer type that is associated with one or more UE bearers/backhaul RLC channels or routes.

In addition to indicating whether the bearer modification is needed for the MCG, SCG, or split bearer, particularly for SN terminated bearers, the bearer change procedure may or may not involve the MN node and can be MN-initiated or SN-initiated.

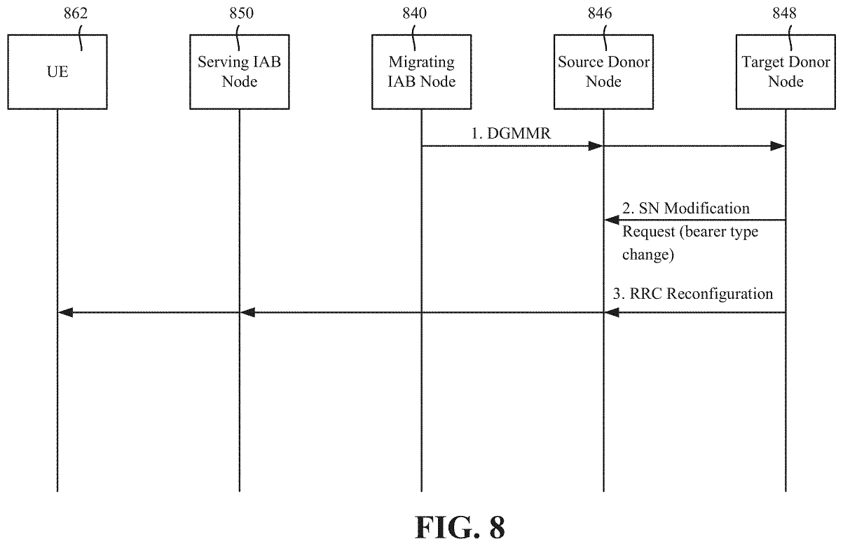

In one alternative, the migrating IAB node or anchor node may provide a T-DGMMR to the MN or SN depending on where the modification is configured to be initiated, or to both in case MN involvement is needed even if the modification is SN-initiated. The messages may be provided directly by the migrating node or may be forwarded as shown in FIG. 8 between source and target nodes 846 and 848m respectively, via inter-donor signaling, which depicts a T-DGMMR procedure for multi-connectivity. An advantage of this approach is that it reduces latency and signaling impact on downstream nodes; however it means that the migrating node 840 needs to be aware of the bearer type configuration of the downstream access UEs (e.g., UE 862) and multi-connectivity configuration of the downstream IAB nodes (e.g., node 850), which may be different from the migrating node 840. For example the migrating IAB node may be operating in single connectivity, while the UEs connected to the anchor IAB node are operating with dual connectivity to multiple serving nodes, which may or may not be part of the same topology or frequency range as the migrating IAB node. As a result, the bearer type configuration for the downstream nodes may need to be provided upon (re)configuration, so that the appropriate T-DGMMR type and destination can be configured.

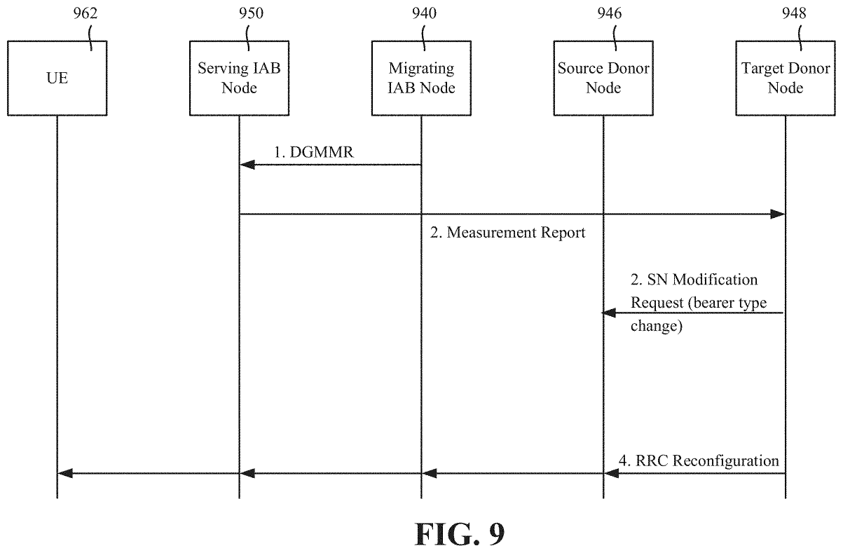

In a second alternative, a two-stage DGMMR is used before MN-initiated or SN-initiated bearer modifications. In a first stage, a D-DGMMR is sent from the migrating node to the anchor node, which indicates a group mobility/topology adaptation procedure is triggered or underway. In a second stage, the bearer modification request message is sent directly from the anchor node to the MN and/or SN based on whether a MN-initiated, SN-initiated, or SN-initiated with MN involvement procedure is being used, as shown in FIG. 9, which depicts a Direct DGMMR procedure for multi-connectivity.

An advantage of this approach is that it does not require upstream migrating IAB nodes to be aware of the multi-connectivity topology or bearer types of the access UEs served by the anchor node. It also may reduce because the anchor node, especially in cases of split bearer configurations, may not need to request any bearer modification during the group mobility/topology adaptation procedure, because it may determine that based on system performance, QoS, or user mobility considerations, the MN-leg or the SN-leg may be sufficient to serve the anchor node and UEs without interruption.

In one example, the DGMMR from the migrating node provides the same or a subset of information as the SN Modification Request message sent by the serving node (MN or SN depending on the initiating node). In a second example, the DGMMR encapsulates the entire or a subset of the SN modification request message prepared by the serving node.

Turning to another aspect, namely a scenario with security key change, for cases when a security key change is needed and the PDCP layer needs to re-established (e.g., when the MCG termination changes in single-connectivity case or SCG termination changes in multi-connectivity case), the technology described herein provides the following group mobility procedure for XNA-based group handover for UEs and IAB-MTs associated with a migrating IAB node. A first operation in inter-donor IAB node migration is a legacy handover procedure for the IAB-MT associated with the migrating IAB node.

In one alternative, before executing the handover procedure for the IAB-MT, the source donor node may do the necessary preparation needed for group handover of UEs and IAB-MTs associated with the migrating node as described herein. Note that this group mobility procedure may be triggered directly by the source donor node in response to the decision to handover the IAB-MT associated with the migrating IAB node, or in response to a DGMMR received from the migrating IAB node.

In this case, before triggering the IAB-MT handover, the source donor node may trigger a group handover request message from the source donor (source gNB) to the target donor node (target gNB).

The group handover request message may contain relevant UE context information for the access UEs associated with the migrating IAB node. However, a significant difference between a regular handover request message and a group handover request message may be that some common information elements for groups of UEs may be aggregated to reduce the overall message size. However, some information elements may need to be UE-specific. For example, the AS security information that contains the security key information may need to be included separately for each UE.

Upon receiving the group handover request message, the target donor (target gNB) may send a group handover request acknowledge message back to the source donor node, including a group RRC reconfiguration message containing the security key update (masterKeyUpdate) information corresponding to the target donor node for each UE or IAB-MT associated with the migrating IAB node. The group RRC reconfiguration message size may be optimized by aggregating common information elements across the group of UEs or IAB-MTs.

Upon receiving the group handover request acknowledge message with the group RRC reconfiguration messages including the security key update information, the source donor node may forward some or all of the group RRC reconfiguration message to the migrating IAB node. Upon receiving the information from the group RRC reconfiguration message, the migrating IAB node may send an acknowledge message back to the source donor indicating that it is now prepared with the information it needs to send individual RRC reconfiguration messages to the associated UEs or DGMMR messages to downstream IAB nodes.

After receiving the acknowledgement message from the migrating IAB node, the source donor may complete the IAB-MT handover procedure. As soon as the IAB-MT handover procedure is completed, the migrating IAB node may then start sending individual RRC reconfiguration messages to its associated UEs and IAB-MTs to provide them with the updated security keys associated with the new target donor. This in turn triggers a re-establishment of PDCP/RLC/MAC layers at the UE. Note that all of this is accomplished without the UEs needing to perform a RACH (random-access channel) procedure.

In a second alternative, the source donor may execute the IAB-MT handover first, before any of the group mobility procedures are triggered. After completion of the group mobility procedure, the source donor may trigger the group mobility procedure, either on its own (because it knows that the IAB-MT is associated with an IAB node), or in response to the DGMMR message received from the migrating IAB node.

In this alternative, the security key information (masterKeyUpdate) generated by the target donor needs to be provided directly to the migrating IAB node encapsulated in a new group RRC reconfiguration message potentially along with other necessary RRC reconfiguration parameters (note that in a legacy handover procedure the target gNB sends the security information to the source gNB).

After the migrating IAB node has received the update security key information and other RRC reconfiguration parameters from the target donor, the migrating IAB node may prepare and send individual RRC reconfiguration message to its associated UEs or send DGMMR messages to IAB-MTs of its downstream IAB nodes to further trigger/complete group mobility for the UEs associated with downstream IAB nodes.

In another alternative, in case of multi-connectivity, the DGMMR can be utilized by the network to trigger an update of the bearer configuration(s) of descendent IAB nodes and UEs of the migrating IAB node such that the termination point (e.g., MN to SN or SN to MN) or the bearer type (from MCG/SCG to split bearer) is modified in such a manner that the security key information does not need to be modified during the group mobility procedure, which can reduce signaling overhead or potentially disruption of user plane data.

The decision of whether to migrate downstream nodes may be configurable by the network as part of the T-DGMMR or DGMMR procedure. In this case, the T-DGMMR or DGMMR message indicates whether downstream nodes below the migrating node should be migrated (e.g. handover, SCG change, bearer reconfiguration, etc.) to the new target donor or remain associated with the source donor even after the migrating node completes its associated procedures. In one example, the indication of downstream migration comprises an explicit field in the T-GDMMR or DGMMR message. In a second alternative, the indication of downstream migration is implicit based on the presence or absence of the downstream node(s) configurations in the T-GDMMR or D-GDMMR message. In a third alternative the indication of downstream migration is (pre) configured by the network using higher-layer (e.g. RRC or F1-AP or OAM) signaling.

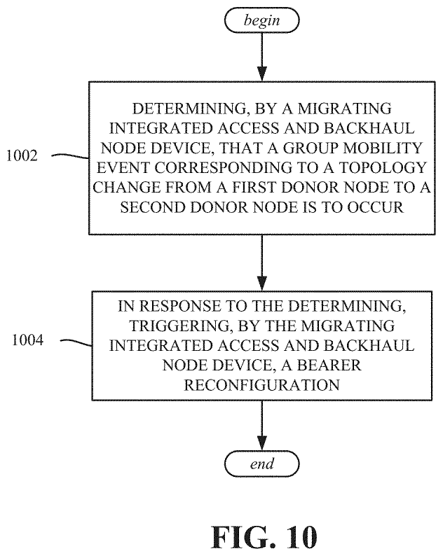

One or more aspects are represented in FIG. 10, and can comprise example operations, such as of a method. Operation 1002 represents determining, by a migrating integrated access and backhaul node device, that a group mobility event corresponding to a topology change from a first donor node to a second donor node is to occur. Operation 1004 represents, in response to the determining, triggering, by the migrating integrated access and backhaul node device, a bearer reconfiguration.

Triggering the bearer reconfiguration can comprise sending a transparent downstream group mobility modification request message to the second donor node.

Triggering the bearer reconfiguration can comprise sending a transparent downstream group mobility modification request message indirectly to the second donor node via an inter-donor node message.

Triggering the bearer reconfiguration can comprise sending a direct downstream group mobility modification request message to one or more descendent nodes of the migrating integrated access and backhaul node device. The downstream group mobility modification request message can comprise a message containing a security key update of an impacted downstream link.

The second donor node can be a master node in a multiple connectivity topology comprising the master node and a secondary node, and triggering the bearer reconfiguration can comprise sending a transparent downstream group mobility modification request message to the master node.

The second donor node can be a secondary node in a multiple connectivity topology comprising a master node and the secondary node, and triggering the bearer reconfiguration can comprise sending a transparent downstream group mobility modification request message to the secondary node.

The second donor node can be a master node in a multiple connectivity topology comprising the master node and a secondary node, and triggering the bearer reconfiguration can comprise sending a transparent downstream group mobility modification request message to the master node and to the secondary node.

The second donor node can be a secondary node in a multiple connectivity topology comprising a master node and the secondary node, and triggering the bearer reconfiguration can comprise sending a transparent downstream group mobility modification request message to the master node and to the secondary node.

Triggering the bearer reconfiguration can comprise sending a direct downstream group mobility modification request message to a master node in a first stage, and in a second stage, sending at least part of the downstream group mobility modification request message containing a security key update from the migrating node to an anchor node in a multiple connectivity topology comprising the master node and a secondary node.

Triggering the bearer reconfiguration can comprise sending a direct downstream group mobility modification request message to a secondary node in a first stage, and in a second stage, sending at least part of the downstream group mobility modification request message containing a security key update from the migrating node to an anchor node in a multiple connectivity topology comprising a master node and a secondary node.

Aspects can comprise triggering, by the migrating integrated access and backhaul node device, an independent security key update for downstream nodes in conjunction with triggering the bearer reconfiguration.

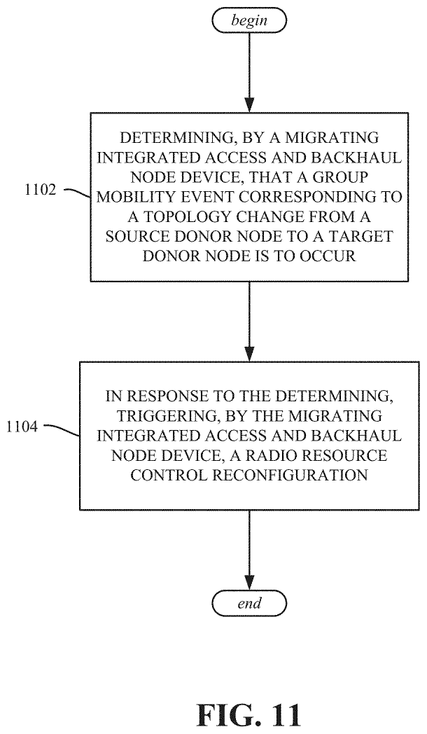

One or more aspects are represented in FIG. 11, and can comprise example operations, such as of a processor and a memory that stores executable instructions or components, that, when executed by the processor, facilitate performance of the example operations. Operation 1102 represents determining, by a migrating integrated access and backhaul node device, that a group mobility event corresponding to a topology change from a source donor node to a target donor node is to occur. Operation 1104 represents, in response to the determining, triggering, by the migrating integrated access and backhaul node device, a radio resource control reconfiguration.

Triggering the radio resource control reconfiguration can comprise sending a transparent downstream group mobility modification request message to the source donor node. Triggering the radio resource control reconfiguration can comprise sending a transparent downstream group mobility modification request message indirectly to the target donor node via an inter-donor node message from the source donor node.

Triggering the radio resource control reconfiguration can comprise sending a direct downstream group mobility modification request message to one or more descendent nodes of the migrating integrated access and backhaul node device. The downstream group mobility modification request message can comprise a message containing a security key update of an impacted downstream link.

The triggering the radio resource control reconfiguration can comprise sending a direct downstream group mobility modification request message to a serving integrated access and backhaul node device that triggers a measurement report.

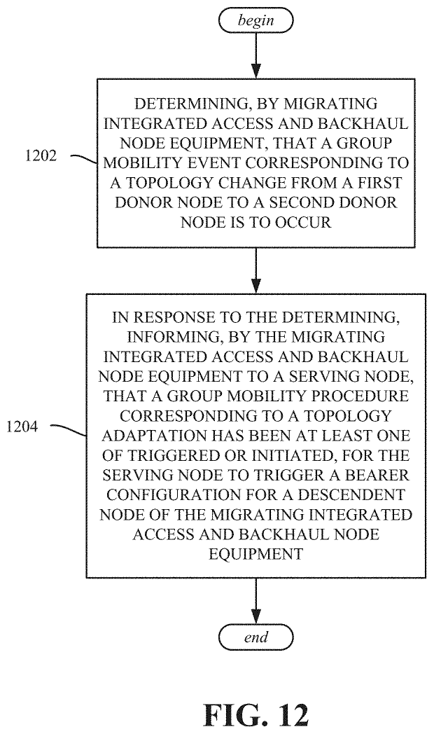

One or more aspects are represented in FIG. 12, and can comprise a machine-readable medium, comprising executable instructions that, when executed by a processor, facilitate performance of example operations. Operation 1204 represents determining, by migrating integrated access and backhaul node equipment, that a group mobility event corresponding to a topology change from a first donor node to a second donor node is to occur. Operation 1204 represents, in response to the determining, informing, by the migrating integrated access and backhaul node equipment to a serving node, that a group mobility procedure corresponding to a topology adaptation has been at least one of triggered or initiated, for the serving node to trigger a bearer configuration for a descendent node of the migrating integrated access and backhaul node equipment.

Further operations can comprise triggering, by the migrating integrated access and backhaul node equipment, an independent security key update for downstream nodes in conjunction with the informing of the group mobility procedure an independent key update in conjunction with the informing of the group mobility procedure.

As can be seen, the technology described herein provides support for group mobility within mobile IAB deployments, where access UEs maintain user plane connectivity to their anchor serving cell even when the mobile IAB performs a mobility procedure (e.g., handover or SCG change)/RRC reconfiguration. The described technology reduces service interruption at the Access UE during the group mobility event because user plane reconfiguration procedures, such as bearer split/switch, are proactively performed before any user plane loss of performance is detected at the donor node. In case of multi-connectivity, master cell group (MCG) bearers, secondary cell group (SCG) bearers, and split bearers can be supported and reconfigured by the mobile IAB architecture during group mobility events. The described technology facilitates reduced signaling overhead and latency, as the existing RRC messages can be reused and assistance information can be provided directly from the migrating IAB nodes to an appropriate IAB donor node where the master node (MN) or secondary (SN) is located. Still further, reduced signaling volume related to security key updates and other inter-gNB handover related messages are provided in scenarios where there is a change of termination point during inter-donor IAB node migration, in both single-connectivity and multi-connectivity cases.

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g., LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

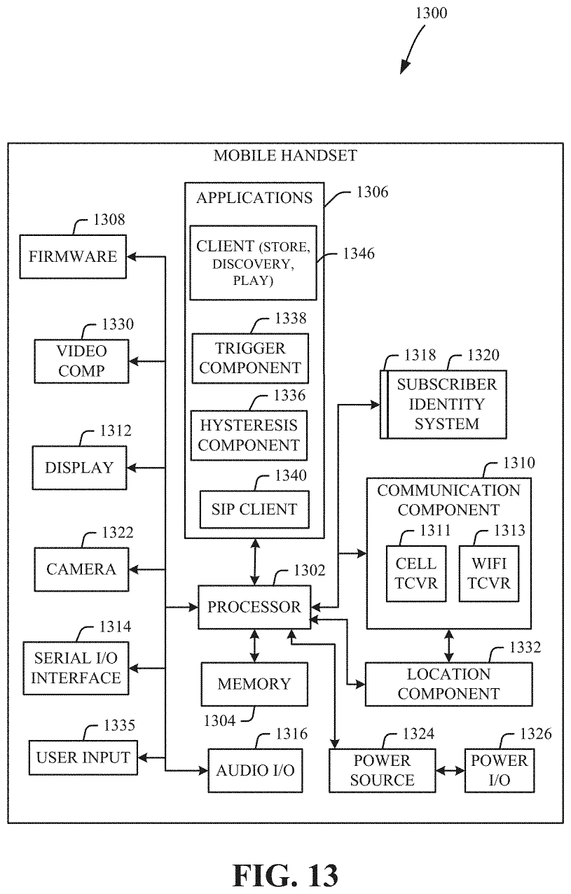

Referring now to FIG. 13, illustrated is a schematic block diagram of an example end-user device such as a user equipment) that can be a mobile device 1300 capable of connecting to a network in accordance with some embodiments described herein. Although a mobile handset 1300 is illustrated herein, it will be understood that other devices can be a mobile device, and that the mobile handset 1300 is merely illustrated to provide context for the embodiments of the various embodiments described herein. The following discussion is intended to provide a brief, general description of an example of a suitable environment 1300 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1300 includes a processor 1302 for controlling and processing all onboard operations and functions. A memory 1304 interfaces to the processor 1302 for storage of data and one or more applications 1306 (e.g., a video player software, user feedback component software, etc.). Other applications can include voice recognition of predetermined voice commands that facilitate initiation of the user feedback signals. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 interfaces to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wi-Fi, WiMax) for corresponding signal communications. The handset 1300 can be a device such as a cellular telephone, a PDA with mobile communications capabilities, and messaging-centric devices. The communications component 1310 also facilitates communications reception from terrestrial radio networks (e.g., broadcast), digital satellite radio networks, and Internet-based radio services networks.

The handset 1300 includes a display 1312 for displaying text, images, video, telephony functions (e.g., a Caller ID function), setup functions, and for user input. For example, the display 1312 can also be referred to as a “screen” that can accommodate the presentation of multimedia content (e.g., music metadata, messages, wallpaper, graphics, etc.). The display 1312 can also display videos and can facilitate the generation, editing and sharing of video quotes. A serial I/O interface 1314 is provided in communication with the processor 1302 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1300, for example. Audio capabilities are provided with an audio I/O component 1316, which can include a speaker for the output of audio signals related to, for example, indication that the user pressed the proper key or key combination to initiate the user feedback signal. The audio I/O component 1316 also facilitates the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process IP data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 1322 (e.g., a camera) can be provided for decoding encoded multimedia content. The video processing component 1322 can aid in facilitating the generation, editing and sharing of video quotes. The handset 1300 also includes a power source 1324 in the form of batteries and/or an AC power subsystem, which power source 1324 can interface to an external power system or charging equipment (not shown) by a power I/O component 1326.

The handset 1300 can also include a video component 1330 for processing video content received and, for recording and transmitting video content. For example, the video component 1330 can facilitate the generation, editing and sharing of video quotes. A location tracking component 1332 facilitates geographically locating the handset 1300. As described hereinabove, this can occur when the user initiates the feedback signal automatically or manually. A user input component 1334 facilitates the user initiating the quality feedback signal. The user input component 1334 can also facilitate the generation, editing and sharing of video quotes. The user input component 1334 can include such conventional input device technologies such as a keypad, keyboard, mouse, stylus pen, and/or touch screen, for example.

Referring again to the applications 1306, a hysteresis component 1336 facilitates the analysis and processing of hysteresis data, which is utilized to determine when to associate with the access point. A software trigger component 1338 can be provided that facilitates triggering of the hysteresis component 1338 when the Wi-Fi transceiver 1313 detects the beacon of the access point. A SIP client 1340 enables the handset 1300 to support SIP protocols and register the subscriber with the SIP registrar server. The applications 1306 can also include a client 1342 that provides at least the capability of discovery, play and store of multimedia content, for example, music.

The handset 1300, as indicated above related to the communications component 810, includes an indoor network radio transceiver 1313 (e.g., Wi-Fi transceiver). This function supports the indoor radio link, such as IEEE 802.11, for the dual-mode GSM handset 1300. The handset 1300 can accommodate at least satellite radio services through a handset that can combine wireless voice and digital radio chipsets into a single handheld device.

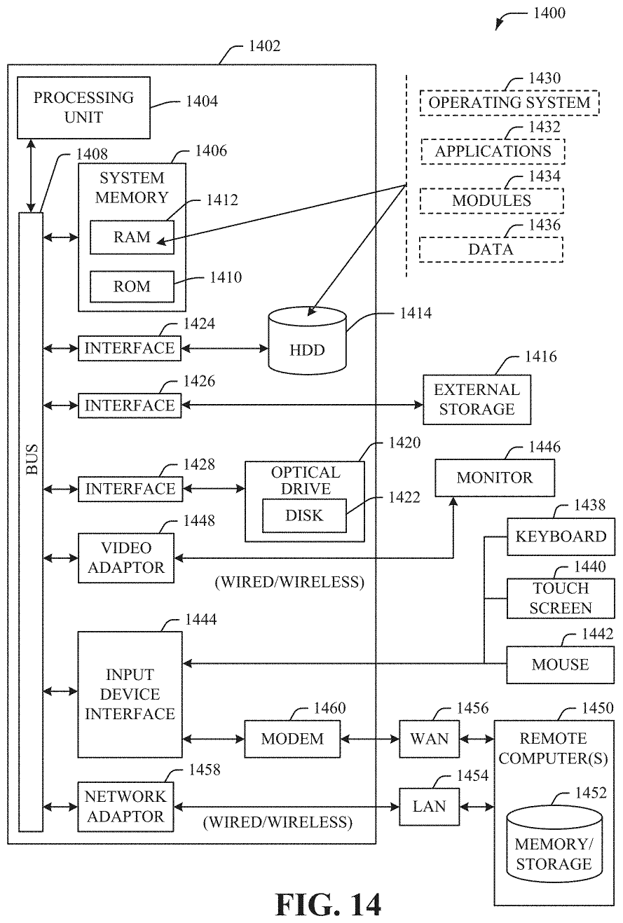

In order to provide additional context for various embodiments described herein, FIG. 14 and the following discussion are intended to provide a brief, general description of a suitable computing environment 1400 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD), non-volatile memory and other storage technology could be used in addition to, or in place of, an HDD 1414, and can be internal or external. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally include emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can include one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 14 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A method, comprising:
determining, by a migrating integrated access and backhaul node device comprising a processor, that a group mobility event corresponding to a topology change from a first donor node to a second donor node is to occur; and
in response to the determining, triggering, by the migrating integrated access and backhaul node device, a bearer reconfiguration.

2. The method of claim 1, wherein triggering the bearer reconfiguration comprises sending a transparent downstream group mobility modification request message to the second donor node.

3. The method of claim 1, wherein triggering the bearer reconfiguration comprises sending a transparent downstream group mobility modification request message indirectly to the second donor node via an inter-donor node message from the source donor node.

4. The method of claim 1, wherein the triggering the bearer reconfiguration comprises sending a direct downstream group mobility modification request message to one or more descendent nodes of the migrating integrated access and backhaul node device.

5. The method of claim 4, wherein the downstream group mobility modification request message comprises a message containing a security key update of an impacted downstream link.

6. The method of claim 1, wherein the second donor node is a master node in a multiple connectivity topology comprising the master node and a secondary node, and wherein triggering the bearer reconfiguration comprises sending a transparent downstream group mobility modification request message to the master node.

7. The method of claim 1, wherein the second donor node is a secondary node in a multiple connectivity topology comprising a master node and the secondary node, and wherein triggering the bearer reconfiguration comprises sending a transparent downstream group mobility modification request message to the secondary node.

8. The method of claim 1, wherein the second donor node is a master node in a multiple connectivity topology comprising the master node and a secondary node, and wherein triggering the bearer reconfiguration comprises sending a transparent downstream group mobility modification request message to the master node and to the secondary node.

9. The method of claim 1, wherein the second donor node is a secondary node in a multiple connectivity topology comprising a master node and the secondary node, and wherein triggering the bearer reconfiguration comprises sending a transparent downstream group mobility modification request message to the master node and to the secondary node.

10. The method of claim 1, wherein triggering the bearer reconfiguration comprises sending a direct downstream group mobility modification request message to a master node in a first stage, and in a second stage, sending at least part of the downstream group mobility modification request message containing a security key update from the migrating node to an anchor node in a multiple connectivity topology comprising the master node and a secondary node.

11. The method of claim 1, wherein triggering the bearer reconfiguration comprises sending a direct downstream group mobility modification request message to a secondary node in a first stage, and in a second stage, sending at least part of the downstream group mobility modification request message containing a security key update from the migrating node to an anchor node in a multiple connectivity topology comprising a master node and a secondary node.

12. The method of claim 1, further comprising, triggering, by the migrating integrated access and backhaul node device, an independent security key update for downstream nodes in conjunction with triggering the bearer reconfiguration.

13. A system, comprising:
a processor; and
a memory that stores executable instructions that, when executed by the processor, facilitate performance of operations, the operations comprising:
determining, by a migrating integrated access and backhaul node device, that a group mobility event corresponding to a topology change from a source donor node to a target donor node is to occur; and
in response to the determining, triggering, by the migrating integrated access and backhaul node device, a radio resource control reconfiguration.

14. The system of claim 13, wherein triggering the radio resource control reconfiguration comprises sending a transparent downstream group mobility modification request message to the source donor node.

15. The system of claim 14, wherein triggering the radio resource control reconfiguration comprises sending a transparent downstream group mobility modification request message indirectly to the target donor node via an inter-donor node message from the source donor node.

16. The system of claim 13, wherein the triggering the radio resource control reconfiguration comprises sending a direct downstream group mobility modification request message to one or more descendent nodes of the migrating integrated access and backhaul node device.

17. The system of claim 16, wherein the downstream group mobility modification request message comprises a message containing a security key update of an impacted downstream link.

18. The system of claim 13, wherein the triggering the radio resource control reconfiguration comprises sending a direct downstream group mobility modification request message to a serving integrated access and backhaul node device node that triggers a measurement report.

19. A non-transitory machine-readable medium, comprising executable instructions that, when executed by a processor, facilitate performance of operations, the operations comprising:
determining, by migrating integrated access and backhaul node equipment, that a group mobility event corresponding to a topology change from a first donor node to a second donor node is to occur; and
in response to the determining, informing, by the migrating integrated access and backhaul node equipment to a serving node, that a group mobility procedure corresponding to a topology adaptation has been at least one of triggered or initiated, for the serving node to trigger a bearer configuration for a descendent node of the migrating integrated access and backhaul node equipment.

20. The non-transitory machine-readable medium of claim 19, wherein the operations further comprise triggering, by the migrating integrated access and backhaul node equipment, an independent security key update for downstream nodes in conjunction with the informing of the group mobility procedure.
